(19) United States
(12) Patent Application Publication
(10) Pub. No.: US 2010/0226688 A1
(43) Pub. Date: Sep. 9, 2010

(54) DEVELOPING DEVICE, PROCESS CARTRIDGE AND IMAGE FORMING APPARATUS

(76) Inventor: Hiroo Soga, Saitama (JP)

Correspondence Address: MORGAN LEWIS & BOCKIUS LLP, 1111 PENNSYLVANIA AVENUE NW, WASHINGTON, DC, 20004, US

(21) Appl. No.: 12/561,724

(22) Filed: Sep. 17, 2009

(30) Foreign Application Priority Data
Mar. 9, 2009 (JP) 2009-055629

(51) Int. Cl. G03G 15/08

(52) U.S. Cl. 399/254

(57) ABSTRACT

A developing device includes: a developing roll; a developer storage chamber; a toner supply chamber into which toner flows through an inflow opening from a toner storage chamber, the toner supply chamber being communicated through an outflow opening with the developer storage chamber; and an agitating member that is disposed inside the toner supply chamber. The agitating member includes: a circular column-shaped shaft portion that has a gradually tapering portion where the shaft diameter of at least a portion of the shaft portion that faces the outflow opening gradually increases in the toner conveyance direction, and spiral blade portions that are disposed on the outer peripheral surface of the shaft portion and that rotate and agitate and convey the toner flowing from the inflow opening into the toner supply chamber to the outflow opening.

### CROSS-REFERENCE TO RELATED APPLICATION

This application is based on and claims priority under 35 USC 119 from Japanese Patent Application No. 2009-55629 filed on Mar. 9, 2009.

### BACKGROUND

1. Technical Field

The present invention relates to a developing device, a process cartridge and an image forming apparatus.

2. Summary

A developing device pertaining to a first aspect of the invention includes: a developing roll that supplies toner to an image holding member on which an electrostatic latent image is formed to thereby visualize the electrostatic latent image as a toner image; a developer storage chamber in which is stored a developer comprising a magnetic carrier and the toner, which are supplied to the developing roll; a toner supply chamber into which the toner flows through an inflow opening from a toner storage chamber in which the toner is stored, the toner supply chamber being communicated through an outflow opening with the developer storage chamber; and an agitating member that is disposed inside the toner supply chamber, agitates and conveys the toner flowing from the inflow opening into the toner supply chamber to the outflow opening, and supplies the toner to the developer storage chamber through the outflow opening, the agitating member including: a circular column-shaped shaft portion that receives driving force and rotates and has a gradually tapering portion where the shaft diameter of at least a portion of the shaft portion that faces the outflow opening gradually increases in the toner conveyance direction, and spiral blade portions that are disposed on the outer peripheral surface of the shaft portion and that rotate and agitate and convey the toner flowing from the inflow opening into the toner supply chamber to the outflow opening.

### BRIEF DESCRIPTION OF THE DRAWINGS

Exemplary embodiments of the present invention will be described in detail based on the following figures, wherein:

FIG. 1 is a plan diagram showing a developing device pertaining to a first exemplary embodiment of the invention;

FIG. 2 is a plan diagram showing a dispense auger used in the developing device pertaining to the first exemplary embodiment of the invention;

FIG. 3 is a perspective diagram showing an outflow opening and the dispense auger used in the developing device pertaining to the first exemplary embodiment of the invention;

FIG. 4 is a plan diagram showing the dispense auger used in the developing device pertaining to the first exemplary embodiment of the invention;

FIGS. 5A and 5B are diagrams showing evaluation results of evaluating the developing device pertaining to the first exemplary embodiment of the invention;

FIGS. 6A and 6B are diagrams showing evaluation results of evaluating the developing device pertaining to the first exemplary embodiment of the invention;

FIGS. 7A and 7B are diagrams showing evaluation results of evaluating a comparative example with respect to the developing device pertaining to the first exemplary embodiment of the invention;

FIG. 8 is a configural diagram showing a process cartridge pertaining to the first exemplary embodiment of the invention;

FIG. 9 is a general configural diagram showing an image forming apparatus in which the developing device pertaining to the first exemplary embodiment of the invention is employed; and

FIG. 10 is a perspective diagram showing an outflow opening and a dispense auger used in a developing device pertaining to a second exemplary embodiment of the invention.

### DETAILED DESCRIPTION

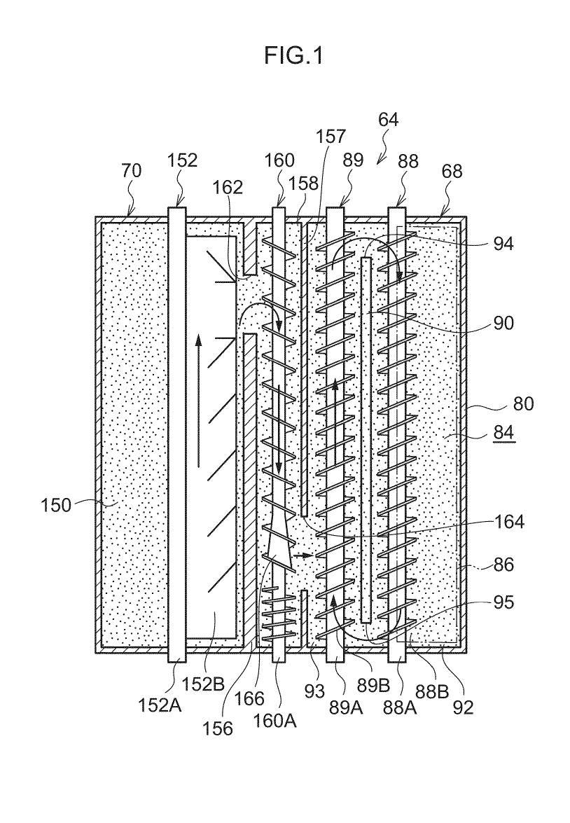

An image forming apparatus in which one example of a developing device and a process cartridge pertaining to a first exemplary embodiment of the present invention is employed will be described in accordance with FIG. 1 to FIG. 9.

(Overall Configuration)

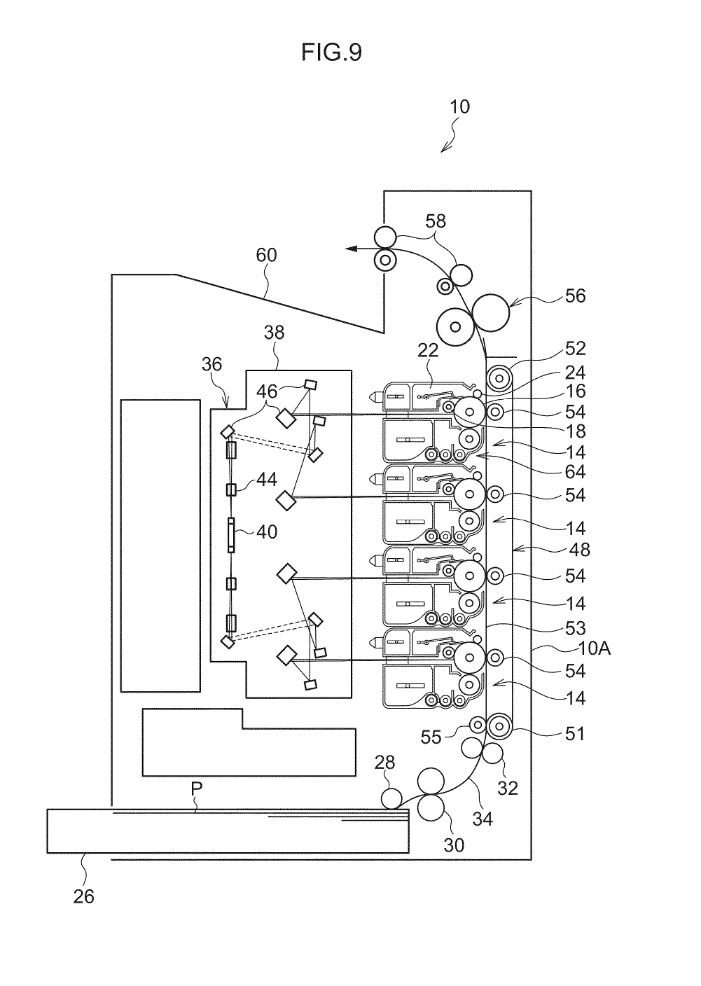

As shown in FIG. 9, in an image forming apparatus 10, process cartridges 14 of four colors (in the present exemplary embodiment, yellow, magenta, cyan and black) are arranged in the vertical direction.

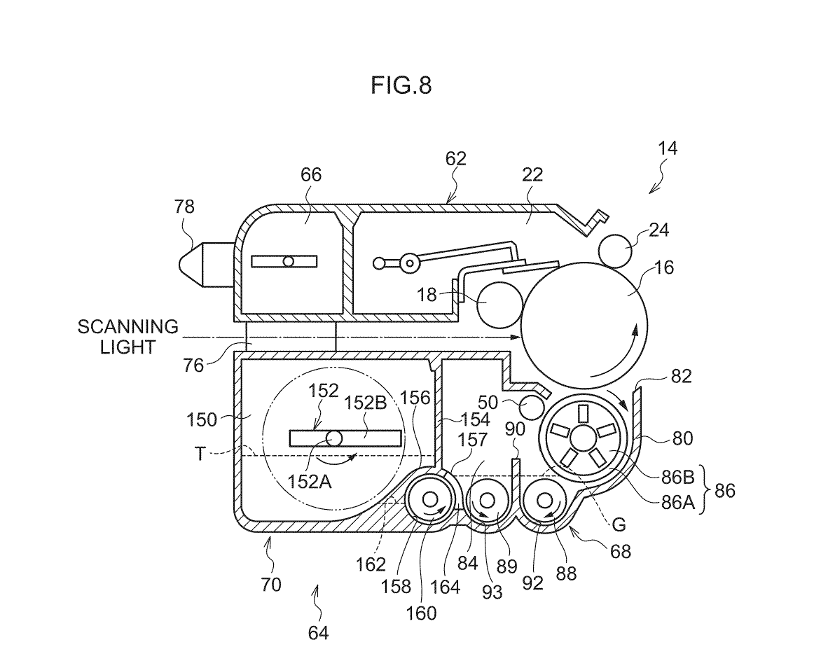

As shown in FIG. 8, each of the process cartridges 14 is configured by a photoreceptor cartridge 62, which includes a photoreceptor 16, and a developing device 64.

The photoreceptor cartridge 62 is configured by: the photoreceptor 16, on which an electrostatic latent image is formed; a cleaning device 22, a charging roll 18 and an erase lamp 24 that are disposed around the photoreceptor 16; and a sub toner replenishing unit 66 that is disposed in the transverse direction of the cleaning device 22.

In the sub toner replenishing unit 66, there are disposed a pair of support projections 78 that extend in a direction orthogonal to the axial direction of the photoreceptor 16. The process cartridge 14 is attached to the image forming apparatus 10 by inserting these support projections 78 into cartridge receiving portions (not shown) in the image forming apparatus 10, and the process cartridge 14 is configured such that it may be freely attached to and detached from the image forming apparatus 10.

Moreover, in the developing device 64, there is disposed a developing roll 86 that conveys a developer G to the photoreceptor 16 to thereby visualize the electrostatic latent image formed on the photoreceptor 16 into a toner image. The details of the developing device 64 will be described later.

Further, as shown in FIG. 9, in the lower portion of the image forming apparatus 10, there is disposed a paper supply cassette 26 in which a sheet material P is stored. In the vicinity of the paper supply cassette 26, there is disposed a pickup roll 28 that feeds the sheet material P at a determined timing. The sheet material P fed from the paper supply cassette 26 by the pickup roll 28 is fed to a paper conveyance path 34 and is conveyed to a later-described conveyance device 48 via conveyance rolls 30 and registration rolls 32.

The process cartridges 14 (see FIG. 8) are disposed in the order of yellow, magenta, cyan and black from the upstream side of the paper conveyance path 34, and an exposure device 36 that irradiates the process cartridges 14 with scanning light is disposed on the side of the process cartridges 14.

The exposure device 36 includes a casing 38, inside of which are disposed a semiconductor laser (not shown), a polygon mirror 40, imaging lenses 44 and mirrors 46, and the light from the semiconductor laser is deflected and scanned by the polygon mirror 40 such that the photoreceptors 16 are irradiated with the light via the imaging lenses 44 and the mirrors 46. Thus, electrostatic latent images corresponding to image information are formed on the photoreceptors 16.

Further, the conveyance device 48 is disposed in a position facing the photoreceptors 16, with the paper conveyance path 34 being interposed between the conveyance device 48 and the photoreceptors 16. The conveyance device 48 is configured by a pair of stretch rolls 51 and 52, which are disposed along a side wall 10A of the image forming apparatus 10, and a conveyor belt 53, which is wrapped around the stretch rolls 51 and 52. The stretch roll 52 is rotated by an unillustrated motor such that the conveyor belt 53 moves.

An attraction roll 55 is disposed in the vicinity of the stretch roll 51, and the sheet material P becomes electrostatically attracted to the conveyor belt 53 as a result of a voltage being applied to the attraction roll 55.

Further, transfer rolls 54 are disposed in positions on the underside of the conveyor belt 53 that face the photoreceptors 16 of each color. The later-described toner images on the photoreceptors 16 are transferred by the transfer rolls 54 onto the sheet material P conveyed by the conveyor belt 53 and are fixed to the sheet material P by a fixing device 56. Then, the sheet material P to which the toner images have been fixed is discharged by discharge rolls 58 into a discharge tray 60.

In the image forming apparatus 10 according to the above-described configuration, an image is formed in the following manner.

As shown in FIG. 8, first, the charging rolls 18 to which a voltage is applied uniformly negatively charge the surfaces of the photoreceptors 16 in an intended charge unit potential.

Electrostatic latent images for which exposure is not performed by the exposure device 36 are formed such that image portions on the charged photoreceptors 16 have an intended exposure unit potential.

That is, latent images corresponding to an image are formed on the photoreceptors 16 by modulating the semiconductor laser by switching it ON and OFF (not shown) on the basis of image data supplied from an unillustrated control device.

Moreover, the developer G is conveyed by the developing rolls 86 disposed in the developing devices 64 to the electrostatic latent images formed on the photoreceptors 16, the toner of the developer G adheres by electric force to the electrostatic latent images, and the electrostatic latent images are visualized as toner images.

And so, as shown in FIG. 9, the sheet material P placed in the paper supply cassette 26 is fed by the pickup roll 28 to the paper conveyance path 34, conveyed at a determined timing by the conveyance rolls 30 and the registration rolls 32, and travels between the photoreceptors 16 and the transfer rolls 54, and the toner images are transferred onto the sheet material P. The transferred toner images are fixed by the fixing device 56, and the sheet material P to which the toner images have been fixed is discharged by the discharge rolls 58 into the discharge tray 60.

(Configurations of Relevant Portions)

Next, the developing devices 64 will be described.

As shown in FIG. 8, each of the developing devices 64 is configured by a developing unit 68, which faces the photoreceptor 16 and visualizes the electrostatic latent image on the photoreceptor 16 with the two-component developer G including a nonmagnetic toner T and a magnetic carrier, and a main toner replenishing unit 70, which replenishes the developing unit 68 with the nonmagnetic toner T.

The developing unit 68 includes a housing 80. The housing 80 is disposed below the photoreceptor 16, and an open portion 82 that opens toward the photoreceptor 16 is formed in the housing 80. Further, a developer storage chamber 84 is formed inside the housing 80, and the developer G including the nonmagnetic toner T and the magnetic carrier is capable of being stored inside the developer storage chamber 84.

Moreover, the developing roll 86 is disposed inside the housing 80 such that part of the developing roll 86 is exposed from the open portion 82 of the housing 80, and the developing roll 86 is rotatably supported in the housing 80. Further, an unillustrated gear is fixed to an end portion of the developing roll 86, and rotational force from a motor is transmitted to the gear such that the developing roll 86 rotates.

Moreover, the developing roll 86 is equipped with a thin, circular cylinder-shaped nonmagnetic sleeve 86A that is conductive and rotatable and a circular column-shaped magnet roll 86B that is fixed.

Further, a circular column-shaped developer regulating roll 50 that serves as a developer regulating member that regulates the layer thickness of the developer G on the developing roll 86 is disposed facing the nonmagnetic sleeve 86A such that there is a clearance therebetween.

Thus, the developing roll 86 attracts the magnetic carrier included in the developer G with magnetic force and forms a magnetic brush of the developer G on its surface, the layer thickness of the developer G is regulated by the developer regulating roll 50, and the developing roll 86 conveys the developer G to a position facing the photoreceptor 16. Then, the electrostatic latent image formed on the photoreceptor 16 is visualized as a toner image by the developer G on the developing roll 86.

Under the developing roll 86, a first agitating and conveying auger 88 and a second agitating and conveying auger 89 are disposed along the axial direction of the developing roll 86.

As shown in FIG. 1, the first agitating and conveying auger 88 and the second agitating and conveying auger 89 are respectively equipped with rotating shafts 88A and 89A and are respectively rotatably supported on the peripheral wall of the housing 80. Further, spiral blades 88B and 89B spiral around and are formed at a determined pitch on the rotating shafts 88A and 89A of the first agitating and conveying auger 88 and the second agitating and conveying auger 89.

Moreover, unillustrated gears are respectively fixed to end portions of the rotating shafts 88A and 89A, and when rotational force from an unillustrated motor is transmitted to the gears such that the first agitating and conveying auger 88 and the second agitating and conveying auger 89 rotate in respectively opposite directions, the developer G stored inside the developer storage chamber 84 is conveyed in the direction of the arrows in FIG. 1 while being agitated by the spiral blades 88B and 89B.

A partition wall 90 is formed between the first agitating and conveying auger 88 and the second agitating and conveying auger 89, and the inside of the developer storage chamber 84 is divided in two by the partition wall 90 into a region (first agitation path) 92 where the first agitating and conveying auger 88 is disposed and a region (second agitation path) 93 where the second agitating and conveying auger 89 is disposed.

Communication openings 94 and 95 are formed in both longitudinal direction end portions of the partition wall 90. The first agitation path 92 and the second agitation path 93 are communicated with each other by the communication openings 94 and 95, the developer G inside the developer storage chamber 84 is conveyed while being agitated inside the first agitation path 92 and the second agitation path 93 by the rotation of the first agitating and conveying auger 88 and the second agitating and conveying auger 89, and the developer G circulates between the first agitation path 92 and the second agitation path 93.

As shown in FIG. 8, in the main toner replenishing unit 70 that is adjacent to the developing unit 68, there is disposed a toner storage chamber 150 in which the replenishment-use toner T is stored. In the toner storage chamber 150, a toner agitating and conveying member 152 is disposed along the axial direction of the developing roll 86.

The toner agitating and conveying member 152 is equipped with a rotating shaft 152A and is rotatably supported on the peripheral wall of the housing 80. A blade 152B is formed at a predetermined pitch on the rotating shaft 152A.

Further, an unillustrated gear is fixed to an end portion of the rotating shaft 152A, and when rotational force from an unillustrated motor is transmitted to the gear such that the toner agitating and conveying member 152 rotates via the gear, the nonmagnetic toner T inside the toner storage chamber 150 is conveyed in the direction of the arrows in FIG. 1 while being agitated by the blade 152B.

A wall portion 154 is disposed between the toner storage chamber 150 and the developer storage chamber 84. A curved wall 156 extends from the lower portion of the wall portion 154 toward the toner storage chamber 150, and a partition wall 157 extends from the lower portion of the wall portion 154 toward the developer storage chamber 84, whereby a dispense chamber 158 that serves as a tunnel-like toner supply chamber is disposed between bottom plates of the housing 80.

As shown in FIG. 1, an inflow opening 162 is formed in the vicinity of one longitudinal direction end portion of the curved wall 156 such that the toner stored in the toner storage chamber 150 flows from the toner storage chamber 150 into the dispense chamber 158. Thus, the nonmagnetic toner T stored inside the toner storage chamber 150 is conveyed inside the toner storage chamber 150 while being agitated by the toner agitating and conveying member 152 and is sent from the inflow opening 162 into the dispense chamber 158.

An outflow opening 164 is formed in the vicinity of the other longitudinal direction end portion of the partition wall 157 such that the toner that has been agitated in the dispense chamber 158 flows out to the developer storage chamber 84. Thus, the nonmagnetic toner T inside the dispense chamber 158 is conveyed inside the dispense chamber 158 while being agitated by a dispense auger 160 that serves as an agitating member and is sent from the outflow opening 164 into the developer storage chamber 84.

As shown in FIG. 8, the outflow opening 164 is formed such that its lower end portion is positioned lower than the surface position of the developer G stored in the developer storage chamber 84. Thus, at least part of the outflow opening 164 is submerged in the developer G stored in the developer storage chamber 84, so that it becomes easier for the nonmagnetic toner T sent from the dispense chamber 158 into the developer storage chamber 84 to get into the developer G and mix together with the developer G stored in the developer storage chamber 84. In this manner, the developer G that has been agitated by the dispense auger 160, the first agitating and conveying auger 88 and the second agitating and conveying auger 89 is attracted by magnetic force to the surface of the developing roll 86.

Here, the dispense auger 160 disposed in the dispense chamber 158 that supplies the toner to the developer storage chamber 84 will be described in detail.

As shown in FIG. 1, the dispense auger 160 includes: a circular column-shaped shaft portion 160A that receives rotational driving force of an unillustrated motor member and rotates; and spiral blade portions 160B that are disposed on the outer peripheral surface of the shaft portion 160A and agitate and convey the toner flowing from the inflow opening 162 into the dispense chamber 158 to the outflow opening 164 while the spiral blade portions 160B rotate. In regard to the spiraling direction of the blade portions 160B, from the inflow opening 162 to the portion of the shaft portion 160A that faces the outflow opening 164, the blade portions 160B spiral in a forward direction such that the toner flowing in from the inflow opening 162 is conveyed to the outflow opening 164, and past the outflow opening 164, the blade portions 160B spiral in the opposite direction so as to draw back, to the outflow opening 164, toner that has passed the outflow opening 164 without being discharged from the outflow opening 164.

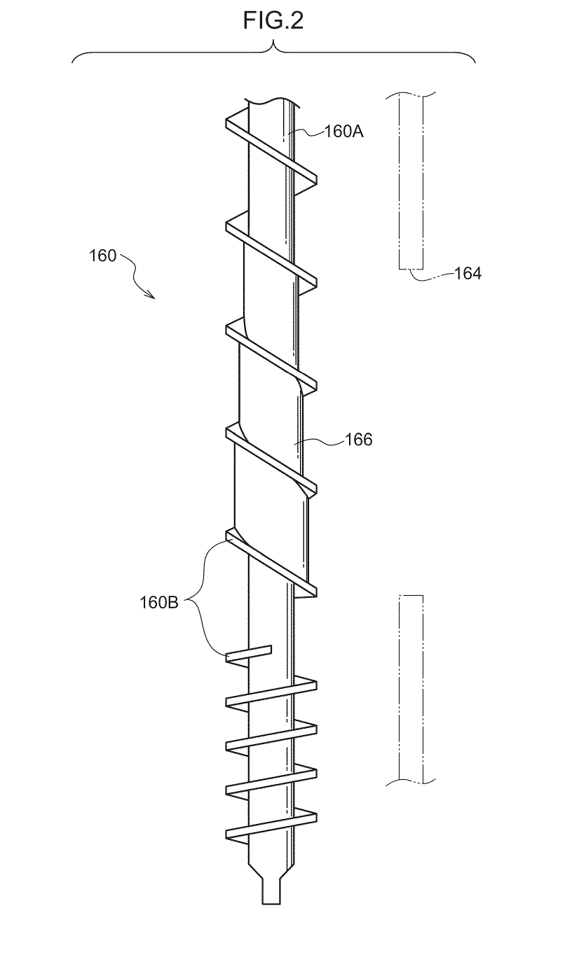

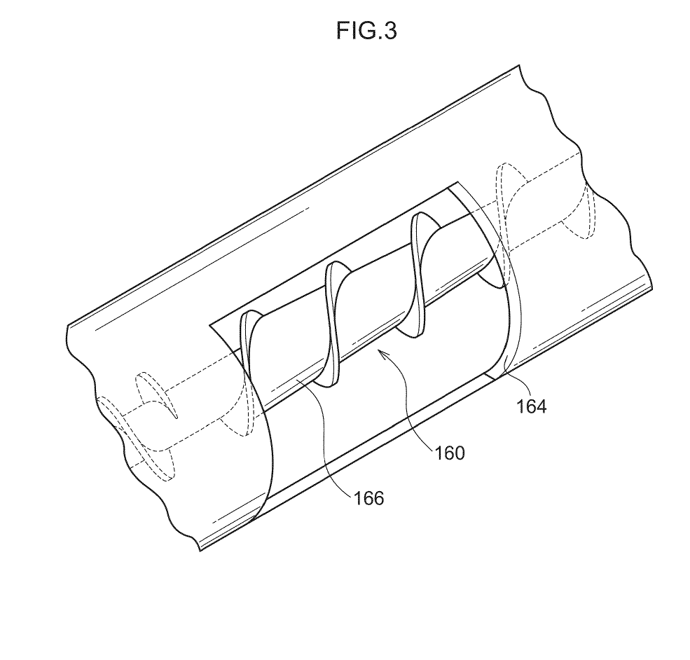

Moreover, as shown in FIG. 2 and FIG. 3, on the portion of the shaft portion 160A that faces the outflow opening 164, there is disposed a gradually tapering portion 166 whose shaft diameter dimension gradually increases in the toner conveyance direction.

(Action)

Next, the action of the main toner replenishing unit 70 will be described.

As shown in FIG. 1, when rotational force from a motor (not shown) is transmitted to the rotating shaft 152A of the toner agitating and conveying member 152 disposed in the toner storage chamber 150, the blade portion 152B rotates, and the nonmagnetic toner T inside the toner storage chamber 150 is conveyed in the direction of the arrows in FIG. 1 while being agitated. Additionally, the toner conveyed by the blade 152B flows from the inflow opening 162 into the dispense chamber 158.

Moreover, the toner flowing from the inflow opening 162 into the dispense chamber 158 is agitated and conveyed toward the outflow opening 164 by the blade portions 160B of the rotating dispense auger 160.

The toner that is conveyed to the outflow opening 164 while being agitated by the dispense auger 160 flows out from the outflow opening 164 to the developer storage chamber 84.

Here, the gradually tapering portion 166 whose shaft diameter dimension gradually increases in the toner conveyance direction is disposed on the shaft portion 160A of the dispense auger 160 that faces the outflow opening 164.

In other words, because the shaft diameter dimension of the shaft portion 160A that faces the outflow opening 164 gradually increases, a pushing force that pushes the toner out through the outflow opening 164 and into the developer storage chamber 84 gradually acts on the conveyed toner.

In this manner, the dispense auger 160 causes pushing force to gradually act on the conveyed toner to thereby control, in the range of the outflow opening 164, imbalance in the amount of the toner supplied from the dispense auger 160 to the developer storage chamber 84 through the outflow opening 164.

Further, because imbalance in the toner amount is controlled and the toner flows out to the developer storage chamber 84, the toner is prevented from being compressed in the axial direction and the problem of soft blocking is eliminated, so it is easy for the toner to be agitated with the developer in the developer storage chamber 84.

Further, because the problem of soft blocking is eliminated, image defects that appear as color stripes in an image as a result of soft-blocked toner being destroyed by the developer regulating roll 50 are prevented.

Here, the inventor in the present application disposes the gradually tapering portion 166 on the dispense auger 160 and evaluates how the toner flows out to the developer storage chamber 84 in the range of the outflow opening 164.

The inventor uses the following parts as evaluation parts.

### —Comparison Part 1—

The inventor evaluates, as a comparative example, a part where the shaft diameter of the shaft portion of the dispense auger is 4 mm, the outer diameter of the blade portions is 8 mm, and the gradually tapering portion is not disposed.

### —Evaluation Part 1—

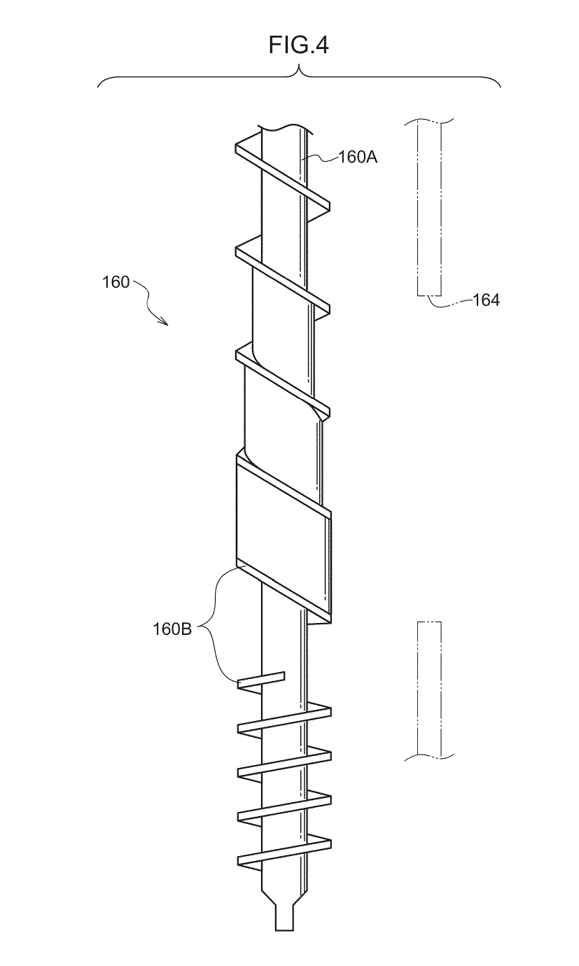

The inventor evaluates a part where the shaft diameter of the shaft portion of the dispense auger is 4 mm, the outer diameter of the blade portions is 8 mm, and the shaft diameter at the gradually tapering portion is gradually changed from 4 mm to 8 mm (see FIG. 4).

### —Evaluation Part 2—

The inventor evaluates a part where the shaft diameter of the shaft portion of the dispense auger is 4 mm, the outer diameter of the blade portions is 8 mm, and the shaft diameter at the gradually tapering portion is gradually changed from 4 mm to 6.5 mm. In other words, the inventor evaluates a part where the dimension of the shaft portion is increased to 1.625 times (6.5 mm) with respect to the outer diameter dimension (4 mm) of a common portion excluding the gradually tapering portion (see FIG. 2).

As the method of evaluation, the inventor divides the outflow opening in three in the longitudinal direction of the dispense auger, measures the weight of the toner flowing out from the respective sites, and compares the amount of the toner flowing out from the respective sites several times. Further, the inventor uses parts where the length of the outflow opening (opening dimension in the toner conveyance direction) is 25 mm and the height (opening dimension in the direction orthogonal to the toner conveyance direction) is 2.5 mm and 5 mm. The reason the inventor changes the height is in order to verify whether or not the height of the outflow opening affects the outflow amount of the toner.

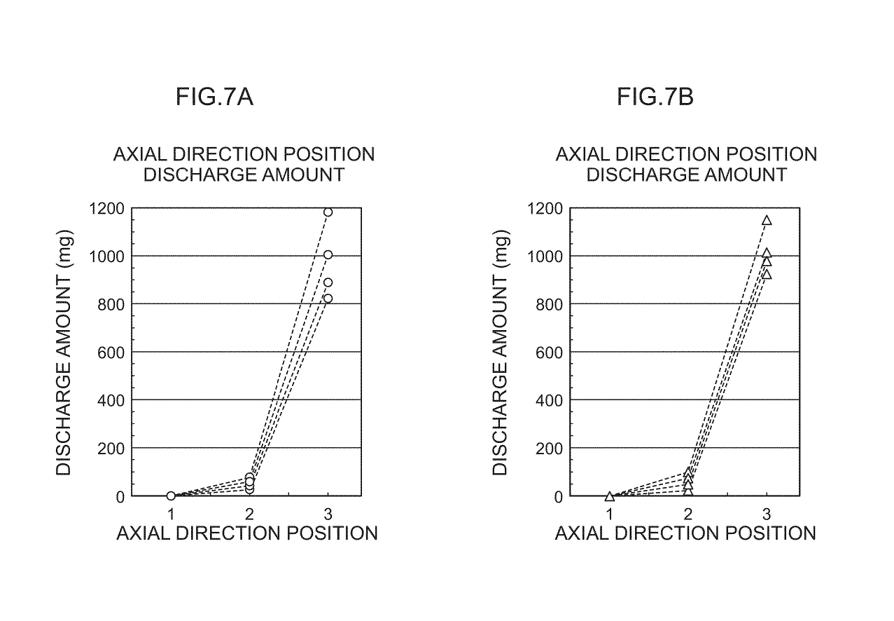

In FIGS. 7A and 7B, there are shown the evaluation results of comparison part 1 that is not equipped with the gradually tapering portion. FIG. 7A is a case where the height of the outflow opening is 5 mm, and FIG. 7B is a case where the height of the outflow opening is 2.5 mm. The vertical axes represent the amount of toner (discharge amount) flowing out from the outflow opening and the horizontal axes represent an outflow portion of the outflow opening. Site 1 is the upstream side in the toner conveyance direction, site 3 is the downstream side in the toner conveyance direction, and site 2 is in the middle of site 1 and site 3.

From FIGS. 7A and 7B, it will be understood that, regardless of the height of the outflow opening, the discharge amounts at site 1 and site 2 are extremely small in comparison to the discharge amount at site 3.

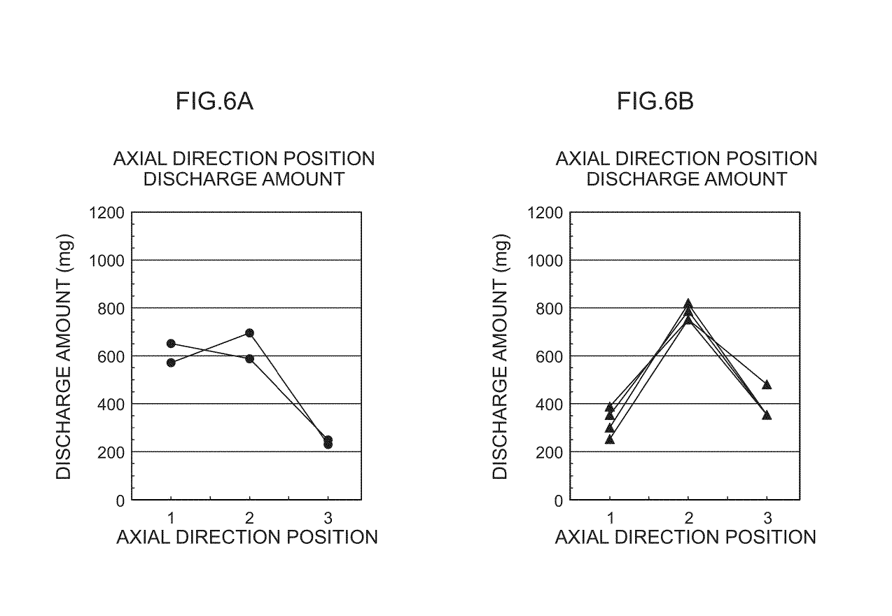

In FIGS. 6A and 6B, there are shown the evaluation results of evaluation part 1 that is equipped with the gradually tapering portion.

From FIGS. 6A and 6B, it will be understood that the toner flows out from site 1 and site 2 in comparison to the evaluation results of comparison part 1 that is not equipped with the gradually tapering portion and that imbalance in the toner amount (discharge amount) is controlled between the sites in comparison to comparison part 1.

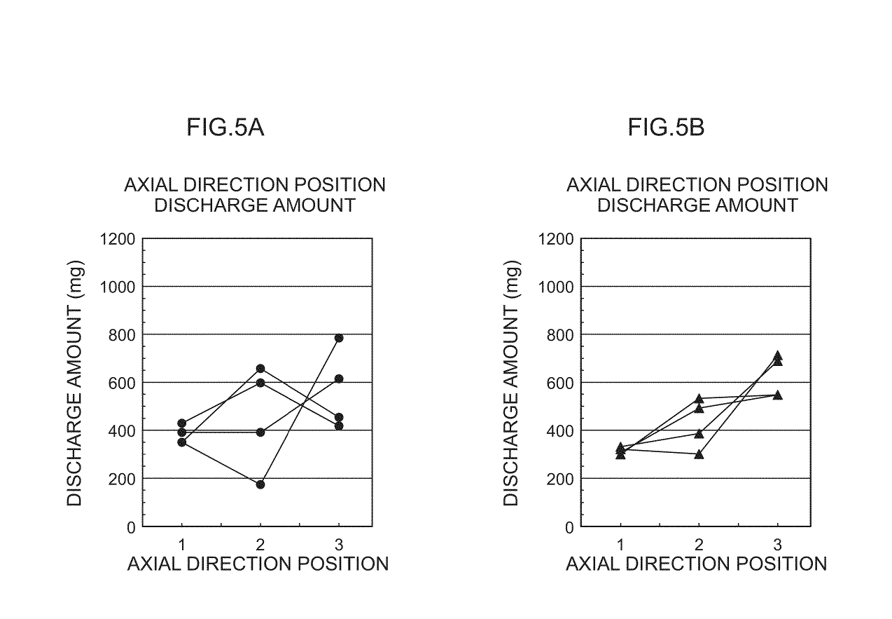

In FIGS. 5A and 5B, there are shown the evaluation results of evaluation part 2 that is equipped with the gradually tapering portion.

From FIGS. 5A and 5B, it will be understood that imbalance in the amount of toner discharged from site 1, site 2 and site 3 is controlled even more in comparison to the evaluation results of evaluation part 1.

From the above evaluation results, it will be understood that, by disposing the gradually tapering portion on the dispense auger, imbalance in the amount of toner supplied from the toner supply chamber to the developer storage chamber through the outflow opening can be controlled in the range of the outflow opening.

The present invention has been described in detail in regard to a specific exemplary embodiment, but the present invention is not limited to this exemplary embodiment, and it will be apparent to practitioners skilled in the art that various other exemplary embodiments are possible within the scope of the present invention. For example, in the preceding exemplary embodiment, the gradually tapering portion 166 was disposed only on the portion of the shaft portion 160A that faces the outflow opening 164, but it suffices for the gradually tapering portion to be disposed at least on the portion of the shaft portion 160A that faces the outflow opening, and the gradually tapering portion may also extend to the portion of the shaft portion 160A that does not face the outflow opening.

Further, in the preceding exemplary embodiment, a configuration where the toner storage chamber 150 in which the toner is stored is disposed integrally with the developing device 64 has been taken as an example and described, but the toner storage chamber may also be disposed separately from the developing device.

Further, in the preceding exemplary embodiment, the gradually tapering portion 166 was formed by increasing the shaft diameter dimension in stages parallel with respect to the outer surface of the shaft portion 160A, but the gradually tapering portion may also be formed by increasing the shaft diameter dimension gradually with respect to the outer surface of the shaft portion 160A.

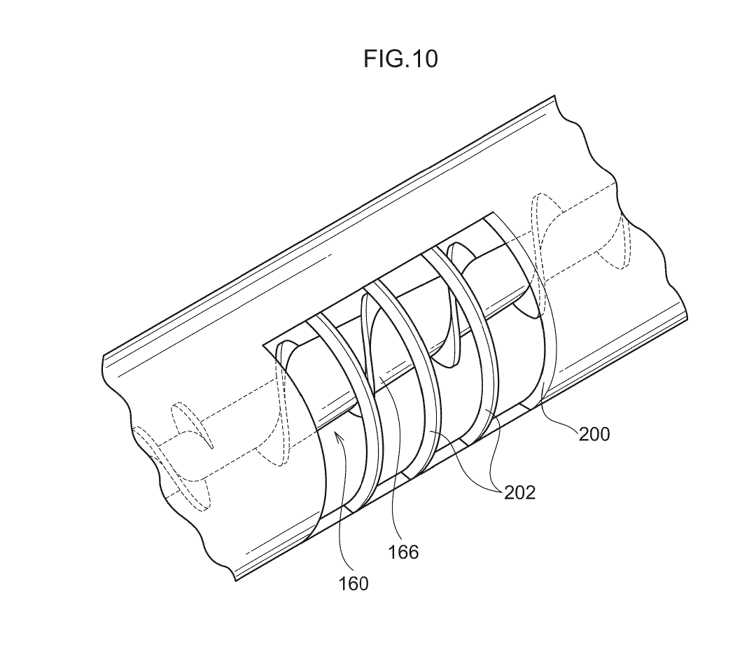

Next, an image forming apparatus in which one example of a developing device and a process cartridge pertaining to a second exemplary embodiment of the present invention is employed will be described in accordance with FIG. 10.

Identical reference numerals will be given to members that are identical to those in the first exemplary embodiment, and description of those identical members will be omitted.

As shown in FIG. 10, in the present second exemplary embodiment, in contrast to the first exemplary embodiment, plural crosspieces 202 that loosen the toner passing through an outflow opening 200 are disposed in the outflow opening 200.

In this manner, by disposing the crosspieces 202, the toner is loosened and the problem of soft blocking can be effectively eliminated.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The exemplary embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A developing device comprising:
a developing roll that supplies toner to an image holding member on which an electrostatic latent image is formed to thereby visualize the electrostatic latent image as a toner image;
a developer storage chamber in which is stored a developer comprising a magnetic carrier and the toner, which are supplied to the developing roll;
a toner supply chamber into which the toner flows through an inflow opening from a toner storage chamber in which the toner is stored, the toner supply chamber being communicated through an outflow opening with the developer storage chamber; and
an agitating member that is disposed inside the toner supply chamber, agitates and conveys the toner flowing from the inflow opening into the toner supply chamber to the outflow opening, and supplies the toner to the developer storage chamber through the outflow opening, the agitating member including:
a circular column-shaped shaft portion that receives driving force and rotates and has a gradually tapering portion where the shaft diameter of at least a portion of the shaft portion that faces the outflow opening gradually increases in the toner conveyance direction, and
spiral blade portions that are disposed on the outer peripheral surface of the shaft portion and that rotate and agitate and convey the toner flowing from the inflow opening into the toner supply chamber to the outflow opening.

2. The developing device according to claim 1, wherein the gradually tapering portion is disposed only at the portion of the shaft portion that faces the outflow opening.

3. The developing device according to claim 1, wherein crosspiece members that loosen the toner passing through the outflow opening are disposed in the outflow opening.

4. The developing device according to claim 3, wherein the crosspiece members are formed so as to extend in a direction perpendicular to the shaft portion and straddle longitudinal direction edge portions of the outflow opening.

5. The developing device according to claim 1, wherein the outer diameter of the shaft portion increases up to 1.625 times at the gradually tapering portion with respect to the outer diameter of a portion other than the gradually tapering portion.

6. A process cartridge comprising:
an image holding member on whose surface an electrostatic latent image is formed; and
the developing device according to claim 1, which visualizes the electrostatic latent image formed on the image holding member as a toner image.

7. An image forming apparatus comprising:
the process cartridge according to claim 6, which is detachably attached to an apparatus body; and
a transfer unit that transfers the toner image formed on the image holding member of the process cartridge onto a recording medium.
